(19) United States
(12) Patent Application Publication
(10) Pub. No.: US 2023/0377403 A1
(43) Pub. Date: Nov. 23, 2023

(54) METHOD FOR PROCESSING VALUE DOCUMENTS, AND VALUE DOCUMENT PROCESSING SYSTEM

(71) Applicant: GIESECKE+DEVRIENT CURRENCY TECHNOLOGY GMBH, Munchen (DE)

(72) Inventors: Tilo FRITZHANNS, Munchen (DE); Ralf HOBMEIER, Munchen (DE); Jens KULIKOWSKI, Oberding (DE); Andrej PIETSCHKER, Munchen (DE)

(21) Appl. No.: 18/031,049

(22) PCT Filed: Sep. 24, 2021
(86) PCT No.: PCT/EP2021/025365

§ 371 Date: Apr. 10, 2023

(30) Foreign Application Priority Data
Oct. 8, 2020 (DE) 10 2020 006 202.4

(51) Int. Cl. G07D 11/22; G07D 11/24

(52) U.S. Cl. CPC G07D 11/22; G07D 11/24

(57) ABSTRACT

A method for processing value documents and to a value document processing system, involve: ascertaining first identification data by means of which the value documents contained in at least one batch of value documents can be identified, in at least one value document processing device; transmitting the first identification data to an external computing device; ascertaining first sorting data in the external computing device by comparing the transmitted first identification data with specified second identification data by means of which value documents can be identified to be removed from circulation and/or remain in circulation; transmitting the first sorting data from the external computing device to the at least one value document processing device; and sorting the value documents contained in the at least one batch in the at least one value document processing device on the basis of the transmitted first sorting data.

The invention relates to a method for processing valuable documents, in particular banknotes, and to a valuable document processing system.

When valuable documents, in particular banknotes, are produced, they are usually provided, in particular by printing, with an identification feature, for example a serial number. On the basis of such an identification feature, it is possible to identify a valuable document and, for example, to assign the latter to a certain production batch. Further, it is possible to track a banknote in circulation by regularly recording the serial number thereof or to register a banknote in a central database, for instance if this banknote was involved in a crime, for example because it was stolen during a bank robbery or was contained in a ransom payment, or if it comes to light that forgeries of this banknote were brought into circulation.

It is an object of the present invention to improve the processing, in particular sorting, of valuable documents.

This object is achieved by the method and by the valuable document processing system according to the independent claims.

The method according to the invention for processing valuable documents, in particular banknotes, includes the following steps: determining first identification data, in particular serial numbers, on the basis of which the valuable documents contained in at least one batch of valuable documents are identifiable, in at least one valuable document processing device; transmitting the first identification data, in particular via an Internet service, to an external computing device; determining first sorting data, which contain serial numbers in particular, in the external computing device by comparing the transmitted first identification data with specified second identification data, in particular serial numbers, on the basis of which valuable documents that should be withdrawn from circulation and/or should remain in circulation are identifiable; transmitting the first sorting data from the external computing device to the at least one valuable document processing device; and sorting the valuable documents contained in the at least one batch in the at least one valuable document processing device on the basis of the transmitted first sorting data.

The valuable document processing system according to the invention for processing valuable documents, in particular banknotes, has at least one valuable document processing device configured to determine first identification data, in particular serial numbers, on the basis of which the valuable documents contained in at least one batch of valuable documents are identifiable, and to transmit the first identification data, in particular via an Internet service, to an external computing device. Moreover, provision is made of an external computing device which is configured to determine first sorting data, which contain serial numbers in particular, by comparing the transmitted first identification data with specified second identification data, in particular serial numbers, on the basis of which valuable documents which should be withdrawn from circulation and/or should remain in circulation are identifiable, and to transmit the determined first sorting data to the at least one valuable document processing device. The at least one valuable document processing device is further configured to sort the valuable documents contained in the at least one batch on the basis of the transmitted first sorting data.

One aspect of the invention is based on the approach of recording first identification data, in particular serial numbers, of the valuable documents which are processed in a first valuable document processing device and which are contained in a batch, for instance in what is known as a deposit, pack or bundle of valuable documents, and of comparing said first identification data with specified second identification data in an external computing device. The second identification data are for example what is known as a whitelist, which contains the identification data of valuable documents provided or released for circulation, or what is known as a blacklist, which contains the identification data of valuable documents to be removed from circulation. The comparison is used to determine first sorting data, which preferably contain the identification data or serial numbers of those valuable documents that should be sorted out or not sorted out. Once the first sorting data determined in this way have been transmitted back from the external computing device, the valuable documents, in particular all valuable documents, contained in the relevant batch are reentered into the first or a second valuable document processing device and sorted there on the basis of the first sorting data, for example by virtue of those valuable documents of the batch which, in accordance with the comparison of the serial number thereof with the whitelist or blacklist carried out in the external computing device, can be returned into circulation being output in one stacker compartment and those value documents which, in accordance with the comparison, should be withdrawn from circulation being output in another stacker compartment. Since preferably only one sorting of the valuable documents is carried out during this renewed processing in the at least one valuable document processing device, it is sufficient if only the first identification data of the valuable documents of the batch are rerecorded or redetermined in the process and are compared with the transmitted sorting data, which in particular contain the serial numbers of valuable documents to be sorted out or not to be sorted out. Depending on the result of this comparison, the individual valuable documents are then output to different stacker compartments, for example, and are available there for generally different further processing.

Since the recording of the first identification data of the valuable documents and the sorting of the valuable documents are carried out in mutually separate process steps, the method can also be referred to as a “2-step process”. In contrast to what is known as a “1-step process”, in which the second process step of sorting is only carried out if a comparison of the identification data with a whitelist and/or blacklist has yielded that the batch contains at least one valuable document that should be withdrawn from circulation, the second process step of sorting is preferably obligatory in the present 2-step process, that is to say the valuable documents contained in the batch or in a part of the batch may only be returned to circulation once the entire batch has been sorted on the basis of the first sorting data.

In the way described above, valuable documents to be sorted out, for example valuable documents that are forged, faulty and/or involved in a crime, can be removed from circulation in a targeted and reliable manner, or all other valuable documents can be reliably returned into circulation. Moreover, the comparison of the first identification data with the specified second identification data carried out in an external computing device—rather than in the respective valuable document processing device—allows said second identification data to be able to be managed, in particular updated, easily and in centralized fashion in the external computing device. The second identification data required for the determination of the sorting data, for example in the form of a whitelist or blacklist, therefore need not be continually updated in decentralized fashion on all relevant valuable document processing devices. As a result of a suitable data connection between the first and/or second valuable document processing device and the external computing device, in particular by way of an Internet service such as file transfer protocol (FTP), email or the World Wide Web (WWW), the valuable documents can be sorted in decentralized or local fashion, that is to say at the location of the first and/or second valuable document processing device, on the basis of the centrally specified, and hence always current, second identification data.

On the basis of the comparison of the first identification data, which in particular allow the individual identification of a valuable document, with the second identification data, it is possible to easily and reliably withdraw from circulation all valuable documents that are no longer capable of circulation or are no longer destined for circulation, for example on account of wear, forgery or illegal transactions.

The first identification data are preferably serial numbers or another individual feature of the respective valuable document, by means of which the individual valuable document can be identified. Alternatively or additionally, the first identification data may however also be information on the basis of which a plurality or multiplicity of valuable documents can be identified, for example an allocation number which indicates the assignment of the valuable documents to, e.g., a batch, a container, packaging or a specific issue or series of valuable documents. On the basis of such an allocation number, it is possible to withdraw from circulation entire series or partial series of valuable documents in a simple manner, for instance if the relevant series have a printing defect or were issued for test purposes and the corresponding number of the valuable paper series is contained in the blacklist.

Overall, the invention therefore allows better processing of valuable documents, in particular simplified and more reliable sorting of valuable documents.

In the case of the present 2-step process, all valuable documents whose first identification data have been determined in the first process step are preferably always sorted in the second process step. By way of example, the first identification data of the valuable documents contained in two or more batches, for example separate deposits, packs or bundles, are recorded or determined in the at least one valuable document processing device, and are forwarded to the external computing device. Following the transmission of the first sorting data, all batches, that is to say all valuable documents contained in the two or more batches, are then supplied to the at least one valuable document processing device for the purpose of sorting on the basis of the first sorting data.

An external computing device should preferably be understood to mean a computer system, in particular a server, which is preferably located at a central location, for example at the headquarters of a central bank, and which can exchange data with the valuable document processing devices via an Internet connection. Alternatively, the external computing device can also be what is known as a cloud, which has a computer network for carrying out the relevant method steps.

In a preferred embodiment, determining the first identification data of the valuable documents and sorting the valuable documents following the transmission of the first sorting data take place in the same valuable document processing device. In this case, the valuable documents are initially supplied to the valuable document processing device for the purpose of determining the first identification data and can subsequently be stored at the device or in the vicinity of the device, or else at different locations, for example within what is known as a cash center, with the result that the valuable document processing device is immediately available again for determining the first identification data of the valuable documents contained in further batches. Only once the first sorting data have been received are the valuable documents contained in the relevant batch then resupplied to the valuable document processing device for the purpose of sorting on the basis of the first sorting data. As a result, the throughput of the batches in the valuable document processing device during the determination of the identity of the valuable documents contained in said batches is not impaired by latency times possibly arising within the scope of comparing the first identification data with the specified second identification data in the external computing device.

In a further preferred embodiment, the first identification data of the valuable documents are determined in a first valuable document processing device and the processing, in particular sorting, of the valuable documents following the transmission of the first sorting data takes place in a second valuable document processing device that differs from the first valuable document processing device. Preferably, the valuable documents in the second valuable document processing device are only still sorted on the basis of the first sorting data, without one or more properties of the valuable documents having to be registered by sensors. As a result, valuable documents that should be withdrawn from circulation can be sorted out easily and reliably. In a manner analogous to the above-described embodiment, the valuable documents in this case are initially supplied to the first valuable document processing device for the purpose of determining the first identification data and can subsequently be stored at the first or second device, or in the vicinity thereof, or else at different locations, for example within a cash center, with the result that the first valuable document processing device is immediately available again for the purpose of determining the first identification data of the valuable documents contained in further batches. Only once the first sorting data have been received are the valuable documents contained in the relevant batch then supplied to the second valuable document processing device for the purpose of sorting on the basis of the first sorting data. In this embodiment too, the throughput of the batches during the determination of the identity of the valuable documents, respectively contained therein, in the first valuable document processing device is not impaired by possible latency times in relation to the check in the external computing device.

Thus, for example, provision can be made for valuable documents supplied to a cash center to be initially counted in a first process step by the first valuable document processing device, for example a counting apparatus, and for the respective first identification data to be recorded in the process (so-called “deposit killing”). In the cash center, the valuable documents can then be processed further, for example checked for authenticity or fitness and/or be stored while the sorting data are determined, preferably simultaneously, in the external computing device. On the basis of the sorting data available following the further processing of the valuable documents in the cash center, the valuable documents are then sorted accordingly by the second valuable document processing device in a second process step. Alternatively, the valuable documents can also be transported to a different cash center after or within the scope of the further processing, in which different cash center the sorting data are made available and the sorting, that is to say the second process step, takes place.

Preferably, the method further includes the following steps: recording one or more properties of each valuable document contained in the at least one batch of valuable documents in the at least one valuable document processing device by means of one or more sensors and generating corresponding sensor data; transmitting the sensor data, in particular via an Internet service, to the external computing device; checking the valuable documents contained in the at least one batch, in particular in respect of authenticity and/or state, on the basis of the sensor data and generating corresponding second sorting data, which contain serial numbers in particular, in the external computing device; transmitting the second sorting data, in particular together with the first sorting data, from the external computing device to the at least one valuable document processing device; and sorting the valuable documents contained in the at least one batch in the at least one valuable document processing device on the basis of the transmitted first and second sorting data. In this way, it is possible to reliably sort the valuable documents in the at least one valuable document processing device not only in respect of their occurrence, for example in a whitelist and/or blacklist, but also in view of sensor data-determinable properties such as authenticity and/or fitness. In particular, the centralized evaluation of the sensor data in the external computing device in this case allows a local evaluation of the sensor data in the valuable document processing device or devices themselves to be dispensed with. For sorting purposes, it is sufficient for the relevant valuable document processing device to be able to merely record or read the identification data, in particular serial numbers, of the valuable documents and then output the valuable documents in sorted fashion on the basis of the first and/or second sorting data, which preferably likewise contain serial numbers, determined in the external computing device.

In a further preferred embodiment, the predetermined second identification data are supplemented with further second identification data which identify valuable documents whose check, in particular with regard to authenticity and/or state, has shown that they should be withdrawn from circulation and/or should remain in circulation. These valuable documents are preferably checked for authenticity and/or state using sensor data generated by sensors of the valuable document processing device and, depending on the result of the check, the associated serial numbers are included as further second identification data in a whitelist or blacklist stored in the external computing device. Within the scope of the usual processing method for valuable documents, this enables simple and reliable updating or expansion of a whitelist or blacklist formed from the predetermined second identification data.

In a further preferred embodiment, the valuable documents contained in the at least one batch or a portion of the valuable documents contained in the at least one batch are only released for circulation again following the determination of the first identification data once the valuable documents contained in the at least one batch have been sorted in the at least one valuable document processing device on the basis of the transmitted first and optionally second sorting data. In the time between determining the first identification data and sorting on the basis of the first and optionally second sorting data, the batch is preferably kept safe or stored outside of the valuable document processing device, possibly after packaging or bundling, for example by means of a currency strap, and said batch is only reinserted into the same valuable document processing device or a different valuable document processing device for sorting purposes, optionally following the removal of the packaging or the currency strap, once the first and optionally second sorting data have been transmitted. Safekeeping or storage of the valuable documents should be understood to mean any type of safekeeping in which they cannot be brought into circulation. By way of example, the valuable documents are packed and/or picked in a cash center and/or kept safe in a vault without being able to leave the cash center.

It is further preferable for transmitting of the first and optionally second sorting data to be followed by rerecording of the first identification data of the valuable documents contained in the at least one batch in the at least one valuable document processing device and for the valuable documents contained in the at least one batch to be sorted in the valuable document processing device on the basis of a comparison of the rerecorded first identification data with the first and optionally second sorting data. Should second sorting data also be available in addition to first sorting data as the result of an authenticity and/or state check of the valuable documents, which is carried out in the external computing device, the valuable documents are preferably only still sorted in the valuable document processing device, without carrying out a (further) authenticity or state check. Then, only the first identification data of the valuable documents need to be redetermined in the valuable document processing device, for example by recording images of the valuable documents and subsequently implementing optical character recognition, without however other properties of the valuable documents needing to be recorded and checked. Overall, this renders the processes when checking and sorting valuable documents in a cash center even simpler and more efficient.

Further advantages, features and options for application of the present invention arise from the following description in conjunction with the figures. In a schematic illustration:

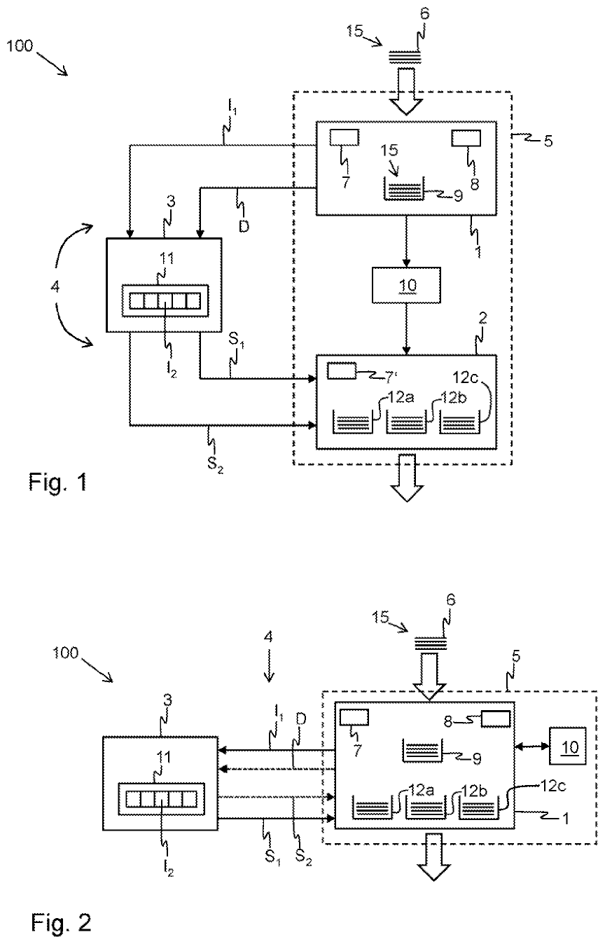

FIG. 1 shows a first example of a valuable document processing system; and

FIG. 2 shows a second example of a valuable document processing system.

FIG. 1 shows a first example of a valuable document processing system 100 having a first valuable document processing device 1, a second valuable document processing device 2, and an external computing device 3, which is connected to the first and the second valuable document processing device 1, 2, for example via an Internet service 4.

The valuable document processing devices 1, 2 are typically operated in a so-called cash center 5 and for example comprise one or more of the following components: a separator for separating valuable documents 6 contained in a provided batch 15, for example in the form of a deposit, bundle or stack, a transport apparatus for transporting valuable documents 6, one or more sensors 8 for recording properties, for example optical, electrical, acoustic or magnetic properties, of the valuable documents 6, an evaluation apparatus for evaluating corresponding sensor data, and a control apparatus for controlling the valuable document processing device 1, 2.

The valuable documents 6 contained in the batches 15 supplied to the cash center 5 are recorded in the first valuable document processing device 1. In the process, first identification data I₁, for example serial numbers printed onto the valuable documents 6, are determined, for instance by virtue of images of the valuable documents 6 recorded by a camera 7 being processed by means of an algorithm for optical character recognition (OCR). Each of the valuable documents 6 contained in the respective batch 15 can be identified on the basis of the first identification data I₁. In the present example, the first valuable document processing device 1 for recording the first identification data I₁ is situated in a cash center 5. However, alternatively, the identification data I₁ may also already have been recorded outside of the cash center 5, for example within the scope of what is known as a deposit killing, and may have then been supplied to the cash center 5 together with the valuable documents 6.

In the present example, one or more properties of the valuable documents 6 are additionally recorded in the first valuable document processing device 1 by means of one or more sensors 8, for example infrared, ultrasonic, magnetic, optical and/or capacitive sensors, and are converted into corresponding sensor data D. Preferably, the sensor data D are assigned to the first identification data I₁ of the valuable documents 6.

On the basis of the sensor data, it is also possible to recognize two or multiple copies of valuable documents 6, output these in a corresponding output compartment of the valuable document processing device 1, 2 and, from there, input these back into the device 1 for determining the first identification data I₁ of the valuable documents 6 contained in the two copies or multiple copies, in order to ensure that the first identification data I₁ of all valuable documents 6 contained in the respective batch 15 are determined.

The first identification data I₁ are transmitted together with the sensor data D to the external computing device 3 via the Internet service 4, while the valuable documents processed in the first valuable document processing device 1 in the present example are output into a stacker 9, from which they can be taken and temporarily stored at a location provided therefor, for example in a vault device 10 within the cash center 5, while the first identification data I₁ are compared with specified second identification data I₂, in particular specified serial numbers, in the external computing device 3.

The second identification data I₂ are stored in a database 11 in the external computing device 3 and preferably form what is known as a whitelist, on the basis of which valuable documents 6 in circulation or destined for circulation can be identified. Alternatively, the second identification data I₂ form what is known as a blacklist, on the basis of which valuable documents 6 to be removed from circulation can be identified. The second identification data I₂, in particular a whitelist and/or blacklist, can be managed, that is to say updated or maintained, centrally in the external computing device 3, which may preferably be a central server or what is known as a cloud service.

First sorting data S₁, which allow the identification of the valuable documents 6 contained in the batch 15 which should remain in circulation or should be removed from circulation, are determined in the external computing device 3 on the basis of the comparison of the first with the second identification data I₁ and I₂, respectively.

At the same time, the sensor data D determined from the valuable documents 6 can be analyzed in the external computing device 3 in respect of authenticity and/or state (what is known as fitness) of the valuable documents 6 and corresponding second sorting data S₂ can be generated, said second sorting data containing the identification data for those valuable documents 6 whose authenticity or state was found to be in order or found not to be in order. Consequently, the second sorting data S₂ for example contain all serial numbers of the valuable documents 6 contained in the batch 15 which are authentic and fit or which are forged and unfit.

Provision can be made for the specified second identification data I₂ in the database 11, especially when this is a blacklist, to be supplemented with identification data of valuable documents 6 which were assessed as forgeries or unfit on the basis of the sensor data D during the authenticity and/or state test

The first and second sorting data S₁, S₂ are transmitted from the external computing device 3 to the second valuable document processing device 2 via the Internet service 4. Transmission can be implemented in different ways, for example by way of a direct file transmission (file transfer) or else via email. As soon as the first and second sorting data S₁, S₂ are available in the cash center 5, the temporarily stored valuable documents 6 can be taken from the vault device 10 and can be supplied to the second valuable document processing device 2. Alternatively, the temporarily stored valuable documents 6 may already be supplied to the second valuable document processing device 2 at an earlier stage, with the second valuable document processing device 2 in this case starting with the sorting of the valuable documents 6 as soon as the first and second sorting data S₁, S₂ have been transmitted.

A time period of several minutes or even hours may elapse in this case between the processing of the valuable documents 6 in the first valuable document processing device 1 and the processing of the valuable documents 6 in the second valuable document processing device 2.

Preferably, the second valuable document processing device 2 is configured to rerecord the first identification data of the valuable documents 6 contained in the batch 15, for example by means of a camera 7′ and an algorithm for optical character recognition. On the basis of a comparison between the rerecorded first identification data and the transmitted first and second sorting data S₁, S₂, the second valuable document processing device 2 is then able to sort the valuable documents 6 and, for example, output these in different stackers 12a, 12b, 12c.

By way of example, all valuable documents 6 with a first value which should remain in circulation according to the first sorting data S₁ and which are fit and authentic according to the second sorting data S₂ are stacked in the first stacker 12a. By way of example, all valuable documents 6 with a second value which should remain in circulation according to the first sorting data S₁ and which are fit and authentic according to the second sorting data S₂ are stacked in the second stacker 12b. By way of example, all valuable documents 6 which should be removed from circulation according to the first sorting data S₁ and/or which are unfit and/or inauthentic according to the second sorting data S₂ are stacked in the third stacker 12c. Alternatively, the valuable documents 6 may in the latter case also be supplied directly to a valuable document destruction device (not shown).

Preferably, the identification data of the valuable documents 6 sorted out in the third stacker 12c can be transmitted to the external computing device 3 via the Internet service 4 so that the specified second identification data I₂ can be updated accordingly in the database 11, for example by virtue of removing from the whitelist the serial numbers of the valuable documents 6 that have been destroyed or taken out of circulation. The serial numbers of destroyed valuable documents 6 are preferably not included in a blacklist in order not to excessively increase the scope of the blacklist.

By contrast, the valuable documents 6 output into the first and second stackers 12a, 12b can leave the cash center 5 and be put back into circulation.

The system described above has the particular advantage that the second identification data 12, for example in the form of a blacklist or whitelist, which contains a large number of entries and therefore requires a lot of storage space, are stored and managed centrally and, for instance, do not have to be available in a decentralized manner in the relevant valuable document processing devices 1, 2 or in each cash center 5. Problems due to insufficient storage and/or computing power of the valuable document processing devices 1, 2 or of the cash center 5 are thereby avoided. Further, on account of the outsourcing of the generally time-consuming comparison or checking process to the external computing device 3, the valuable document processing devices 1, 2 are only required during the recording of the first identification data or sorting of the valuable documents contained in a batch and are then immediately available again for further batches, whereby overall an efficient processing of a number or multiplicity of valuable document batches is made possible.

As an alternative to the above-described example of a valuable document processing system 100, in which the determination of the first identification data of the valuable documents 6 and sorting of the valuable documents 6 using the first and optionally second sorting data are carried out in different valuable document processing devices 1, 2, it is possible to carry out both process steps in just one valuable document processing device appropriately configured to this end, as will be explained in more detail below.

FIG. 2 shows a second example of a valuable document processing system 100, which has a valuable document processing device 1 located in a cash center 5 and an external computing device 3 which is connected to the valuable document processing device 1 by way of an Internet service 4.

Like in the case of the example shown in FIG. 1, first identification data I₁, in particular serial numbers, of the valuable documents 6 respectively contained in a batch 15 are also determined in the present example in the valuable document processing device 1 by virtue of the images of the valuable documents 6 recorded by a camera 7 being analyzed by means of optical character recognition (OCR). Further, one or more properties of the valuable documents 6 are recorded by means of one or more sensors 8 and are converted into corresponding sensor data D, which are assigned to the first identification data I₁ of the valuable documents 6. Possible two or multiple copies of valuable documents 6 can also be recognized on the basis of the sensor data D, can be output into a corresponding output compartment and, from there, can be reentered into the device 1, in order also to reliably determine the first identification data I₁ of the valuable documents 6 contained in the two or multiple copies.

The first identification data I₁ are transmitted together with the sensor data D to the external computing device 3 via the Internet service 4. The valuable documents 6 are output into a stacker 9, from which they can be taken and temporarily stored at a location provided to this end, for example in a vault device 10 within the cash center 5, while the first identification data I₁ are compared with specified second identification data I₂ in the external computing device 3 and the sensor data D are analyzed in respect of authenticity and/or state (so-called fitness) of the valuable documents 6, with first and second sorting data S₁ and S₂, respectively, being generated and transmitted back to the cash center 5, in particular to the valuable document processing device 1, via the Internet service 4. The statements made above in conjunction with the example shown in FIG. 1 apply accordingly in respect of the comparison of the first identification data I₁ with the specified second identification data I₂ and the checking of the valuable documents 6 on the basis of the sensor data D in the external computing device 3.

After the first and second sorting data S₁ and S₂, respectively, have been transmitted to the cash center 5 or the valuable document processing device 1, the valuable documents 6, which were for example temporarily stored in the vault device 10 of the cash center 5, are resupplied to the valuable document processing device 1 and are sorted on the basis of the first and second sorting data S₁ and S₂, respectively, by virtue of said valuable documents being output into different stackers 12a, 12b, 12c. By way of example, if only valuable documents 6 which should remain in circulation according to the first sorting data S₁ and which are fit and authentic according to the second sorting data S₂ are output into the stackers 12a and 12b, then these valuable documents can leave the cash center 5 and can be brought back into circulation. By contrast, if valuable documents 6 which should be removed from circulation according to the first sorting data S₁ and/or which are unfit and/or inauthentic according to the second sorting data S₂ are output into the stacker 12c, these valuable documents are treated separately and optionally destroyed. Otherwise, the statements made above in conjunction with the example shown in FIG. 1 apply accordingly.

The check of the valuable documents 6 on the basis of the sensor data D can—as an alternative or in addition to a test carried out in the external computing device 3—also be carried out in the valuable document processing device 1 itself, with corresponding second sensor data S₂ being generated and also being taken into account in addition to the first sorting data S₁ when sorting the valuable documents 6.

A whitelist stored in a database 11 of a valuable document processing system 100 according to FIG. 1 or 2 is preferably created or updated according to the method described in more detail below.

Preferably, valuable documents are already provided during their production with second identification data, in particular serial numbers, which are recorded during or after their production and stored in the database 11. The second identification data are linked in the database 11 preferably with specific features of the valuable documents or production parameters, for example by virtue of said data being labeled as “not issued” and/or labeled with the time and/or place of production.

At the time the valuable documents are issued, that is to say when the valuable documents are put into circulation, the corresponding identification data in the database 11 are then labeled as “issued”, with the result that all second identification data with the “issued” feature then form the whitelist.

If valuable documents in circulation are later destroyed in a valuable document processing device, the identification data of these valuable documents can be recorded in the process and transmitted to the database 11. In the process, a search is made in the database 11, that is to say in the whitelist, for the corresponding identification data of the destroyed valuable documents and these are labeled as “destroyed”.

Further features of the valuable documents relating to the valuable documents and/or the destruction process can also be recorded and transmitted and linked to the second identification data in the database 11. Such features can be, for example, the time and place of destruction, an identification number of the valuable document processing device and/or identification information of a user.

Alternatively, the second identification data in the database 11 can also be updated manually, for example by virtue of labeling identification data from valuable documents that have not been destroyed by a valuable document processing device as “destroyed”.

An up-to-date whitelist is always available in the database 11 as a result of this method.

Further preferred aspects in connection with the comparison of first and second identification data and the maintenance or updating of the whitelist are described below.

When the first and second identification data are compared in the external computing device 3, the second identification data I₂ stored in the database 11 are preferably searched for the transmitted first identification data I₁. If the second identification data I₂ that correspond to the first identification data I₁ are found, the date and time of the comparison of the first identification data I₁ with the second identification data I₂ can be stored in the database 11 and linked with the second identification data I₂.

If no second identification data I₂ that correspond to the first identification data I₁ are found or if the found second identification data I₂ are not labeled as “issued”, for example are labeled as “not issued” or “destroyed”, then the corresponding first identification data I₁ are transmitted to the cash center 5, for example to a database or another management system of the cash center 5 (a so-called vault management system), as first sorting data S₁. The first sorting data S₁ can then be included in a local blacklist in the cash center 5 and be made available to the valuable document processing devices of the cash center 5. In this way, the local blacklist in the cash center is preferably updated at regular time intervals, for example every 10 minutes.

With every further processing of the valuable documents by the valuable document processing devices in the cash center 5, for example when sorting according to value and/or wear, the first identification data I₁ of the valuable documents are rerecorded and compared with the local blacklist, in particular the first sorting data S₁. If there is a match between first identification data I₁ and the local blacklist or the first sorting data S₁, then appropriate messages can be output to an employee of the cash center 5 and the valuable documents in question can be output into an output compartment for rejected valuable documents, from where they can be removed by the employee and fed to a separate processing for valuable documents suspected of being forged.

1.-8. (canceled)

9. A method for processing valuable documents comprising the steps of:
determining first identification data on the basis of which the valuable documents contained in at least one batch of valuable documents are identifiable, in at least one valuable document processing device,
transmitting the first identification data via an Internet service, to an external computing device,
determining first sorting data, which contain serial numbers, in the external computing device by comparing the transmitted first identification data with specified second identification data, on the basis of which valuable documents that should be withdrawn from circulation and/or should remain in circulation are identifiable,
transmitting the first sorting data from the external computing device to the at least one valuable document processing device, and
sorting the valuable documents contained in the at least one batch in the at least one valuable document processing device on the basis of the transmitted first sorting data.

10. The method according to claim 9, wherein the determination of the first identification data of the valuable documents and the sorting of the valuable documents are implemented in the same valuable document processing device.

11. The method according to claim 9, wherein the first identification data of the valuable documents are determined in a first valuable document processing device and the sorting of the valuable documents is implemented in a second valuable document processing device that differs from the first valuable document processing device.

12. The method according to claim 9, further comprising the steps of:
recording one or more properties of each valuable document contained in the at least one batch of valuable documents in the at least one valuable document processing device by means of one or more sensors, and generating corresponding sensor data,
transmitting the sensor data to the external computing device,
checking the valuable documents contained in the at least one batch on the basis of the sensor data and generating corresponding second sorting data, which contain serial numbers,
transmitting the second sorting data together with the first sorting data, from the external computing device to the at least one valuable document processing device, and
sorting the valuable documents contained in the at least one batch in the at least one valuable document processing device on the basis of the transmitted first and second sorting data.

13. The method according to claim 9, wherein the specified second identification data are supplemented with the further second identification data that identify valuable documents, the check of which has yielded that they should be withdrawn from circulation and/or should remain in circulation.

14. The method according to claim 9, wherein the valuable documents contained in the at least one batch or a portion of the valuable documents contained in the at least one batch are only released for circulation again following the determination of the first identification data once the valuable documents contained in the at least one batch have been sorted in the at least one valuable document processing device on the basis of the transmitted first and optionally second sorting data.

15. The method according to claim 9, wherein transmitting of the first and optionally second sorting data is followed by rerecording of the first identification data of the valuable documents contained in the at least one batch in the at least one valuable document processing device and the valuable documents contained in the at least one batch are sorted in the at least one valuable document processing device on the basis of a comparison of the rerecorded first identification data with the first and optionally second sorting data.

16. A valuable document processing system for processing valuable documents comprising:
at least one valuable document processing device configured to determine first identification data on the basis of which the valuable documents contained in at least one batch of valuable documents are identifiable, and to transmit the first identification data to an external computing device, and
an external computing device configured to determine first sorting data by comparing the transmitted first identification data with specified second identification data on the basis of which valuable documents which should be withdrawn from circulation and/or should remain in circulation are identifiable, and to transmit the determined first sorting data to the at least one valuable document processing device,
wherein the at least one valuable document processing device is further configured to sort the valuable documents contained in the at least one batch on the basis of the transmitted first sorting data.
